(19) United States
(12) Patent Application Publication
(10) Pub. No.: US 2024/0401180 A1
(43) Pub. Date: Dec. 5, 2024

(54) ALUMINUM COPPER LITHIUM ALLOY WITH IMPROVED MECHANICAL STRENGTH AND TOUGHNESS

(71) Applicant: CONSTELLIUM ISSOIRE, Issoire (FR)

(72) Inventors: Ricky WHELCHEL, Grenoble (FR); Alireza ARBAB, Rives-sur-fure (FR); Bernard BES, Seyssins (FR); Christophe SIGLI, Grenoble (FR)

(21) Appl. No.: 18/678,051

(22) Filed: May 30, 2024

Related U.S. Application Data
(63) Continuation of application No. 15/780,273, filed on May 31, 2018.

(30) Foreign Application Priority Data
Dec. 4, 2015 (FR) 1561852

(51) Int. Cl. C22F 1/057; C22C 21/14; C22C 21/16; C22C 21/18; C22F 1/00

(52) U.S. Cl. CPC C22F 1/057; C22C 21/14; C22C 21/16; C22C 21/18; C22F 1/002

(57) ABSTRACT

The invention is a rolled and/or forged product, made of an aluminium-based alloy comprising, in % by weight, Cu: 3.2-4.0; Li: 0.80-0.95; Zn: 0.45-0.70; Mg: 0.15-0.7; Zr: 0.07-0.15; Mn: 0.1-0.6; Ag: <0.15; Fe+Si≤0.20; at least one element from Ti: 0.01-0.15; Se: 0.02-0.1; Cr: 0.02-0.1; Hf: 0.02-0.5; V: 0.02-0.1; other elements ≤0.05 each and ≤0.15 in total, remainder aluminium. In the process for manufacturing the products according to the invention a bath of liquid metal based on aluminium as alloy according to the invention is melted, an unwrought product is cast from said bath of liquid metal; said unwrought product is homogenized at a temperature between 450° C. and 550° C.; said unwrought product is hot worked and optionally cold worked preferably to a thickness of at least 15 mm: said product is solution treated between 490° C. and 530° C. for 15 min to 8 h and quenched; said product is drawn in a controlled manner with a permanent deformation of 1% to 7% and a tempering of said product is carried out. The product is advantageous for the manufacture of an aircraft structural component.

### CROSS-REFERENCE TO RELATED APPLICATIONS

This application is continuation application of 15/780,273, filed May 31, 2018, which is a National Stage entry of International Application No. PCT/FR2016/053175, filed Dec. 1, 2016, which claims priority to French Patent Application No. 1561852, filed Dec. 4, 2015.

### BACKGROUND

### Field

The invention relates to aluminum-copper-lithium alloy products, and more particularly such products and methods of manufacturing and use, intended particular for aeronautical and aerospatial construction.

### Description of Related Art

Products, and particularly thick rolled and/or forged products made of aluminum alloy, are developed to produce high strength parts intended particularly for the aeronautical industry, the aerospatial industry or mechanical construction, by cutting, surfacing or machining from one block. Aluminum alloys containing lithium are very attractive in this respect because lithium can reduce the density of aluminum by 3% and increase the modulus of elasticity by 6% for each percent by weight of lithium added. If these alloys are to be selected for use in aircraft, their performance in service must be as good as that of currently used alloys, particularly in terms of a balance between static mechanical strength properties (yield stress, ultimate strength) and damage tolerance properties (toughness, resistance to propagation of fatigue cracks), these properties generally being antinomic. For thick products, these products must be obtained particularly at quarter-thickness and at mid-thickness and therefore the products must have low sensitivity to quenching. It is said that a product is sensitive to quenching if its static mechanical properties such as its yield stress decrease as the quenching rate decreases. The quenching rate is the average cooling rate of the product during quenching.

These alloys must also have sufficient resistance to corrosion, it must be possible to shape them using normal methods, and they must have low residual stresses so that they can be integrally machined.

Several Al—Cu—Li alloys are known in which silver is added.

Patent U.S. Pat. No. 5,032,359 describes a large family of aluminum-copper-lithium alloys in which the addition of magnesium and silver, particularly between 0.3 and 0.5 percent by weight, can increase the mechanical strength.

U.S. Pat. No. 7,229,509 describes an alloy containing (% by weight): (2.5-5.5) of Cu, (0.1-2.5) of Li, (0.2-1.0) of Mg, (0.2-0.8) of Ag, (0.2-0.8) of Mn, 0.4 max of Zr or other grain refining agents such as Cr, Ti, Hf, Sc, V, particularly with toughness K_{1C}(L)>37.4 MPa√m for yield stress R_{p0.2}(L)>448.2 MPa (products thicker than 76.2 mm) and particularly toughness K_{1C}(L)>38.5 MPa√m for yield stress R_{p0.2}(L)>489.5 MPa (products thinner than 76.2 mm).

The AA2050 alloy comprises (% by weight): (3.2-3.9) of Cu, (0.7-1.3) of Li, (0.20-0.6) of Mg, (0.20-0.7) of Ag, 0,25max. of Zn, (0.20-0.50) of Mn, (0.06-0.14) of Zr and the AA2095 alloy comprises (3.7-4.3) of Cu, (0.7-1.5) of Li, (0.25-0.8) of Mg, (0.25-0.6) of Ag, 0.25max. of Zn, 0.25 max. of Mn, (0.04-0.18) of Zr. AA2050 alloy products are known for their quality in terms of static mechanical strength and toughness, particularly for thick rolled products and are selected for some aircraft.

Patent application WO2009036953 describes an alloy with composition as a % by weight equal to Cu 3.4 to 5.0, Li 0.9 to 1.7, Mg 0.2 to 0.8, Ag 0.1 to 0.8, Mn 0.1 to 0.9, Zn up to 1.5, and one or several elements chosen from the group composed of: (Zr about 0.05 to 0.3, Cr about 0.05 to 0.3, Ti about 0.03 to 0.3, Sc about 0.05 to 0.4, Hf about 0.05 to 0.4), Fe<0.15, Si<0.5, normal and inevitable impurities, the remainder being aluminum.

Patent application US 2009/142222 A1 describes alloys comprising (% by weight), 3.4 to 4.2% of Cu, 0.9 to 1.4% of Li, 0.3 to 0.7% of Ag, 0.1 to 0.6% of Mg, 0.2 to 0.8% of Zn, 0.1 to 0.6% of Mn and 0.01 to 0.6% of at least one element for controlling the granular structure.

Patent application WO2011130180 describes strain hardened aluminum alloy products containing (in % by weight) from 2.75 to 5.0% of Cu, from 0.2 to 0.8% of Mg, in which the copper to magnesium (Cu/Mg) ratio in the aluminum alloy is within the range from about 6.1 to environ 17, from 0.1 to 1.10% of Li, from 0.3 to 2.0% of Ag, from 0.5 to 1.5% of zinc, up to 1.0% of Mn, the remainder being ‘aluminum, optional accessory elements and impurities.

Patent application WO2013169901 describes aluminum alloys containing (in % by weight) from 3.5 to 4.4% of Cu, 0.45 to 0.75% of Mg, from 0.45 to 0.75% of Zn, 0.65-1.15% of Li, 0.1 to 1.0% of Ag, 0.05 to 0.50% of at least one grain structure control element, up to 1.0% de Mn, up to 0.15% of Ti, up to 0.12% of Si, up to 0.15% Fe, up to 0.10% of any other element, with the total of these elements not exceeding 0.35%, the remainder being aluminum.

Al—Cu—Li alloys are also known in which the addition of silver is optional or is not mentioned.

U.S. Pat. No. 5,455,003 describes a method of manufacturing Al—Cu—Li alloys that have improved mechanical strength and toughness at cryogenic temperatures, particularly due to appropriate strain hardening and ageing. In particular, this patent recommends the following composition as a percentage by weight: Cu=3.0-4.5, Li=0.7-1.1, Ag=0-0.6, Mg=0.3-0.6 and Zn=0-0.75.

U.S. Pat. No. 5,211,910 describes alloys that may comprise (as a % by weight) from 1 to 7% of Cu, from 0.1 to 4% of Li, from 0.01 to 4% of Zn, from 0.05 to 3% of Mg, from 0.01 to 2% of Ag, from 0.01 to 2% of a grain refiner chosen from among Zr, Cr, Mn, Ti, Hf, V, Nb, B and TiB2, the remainder being Al with accidental impurities.

U.S. Pat. No. 5,234,662 describes alloys with composition (% by weight) equal to Cu=2.60-3.30, Mg=0.0-0.50, Li=1.30-1.65, Mg: 0.0-1.8, elements controlling the granular structure chosen from among Zr and Cr=0.0-1.5.

One embodiment of U.S. Pat. No. 5,259,897 describes a method of making aluminum-based alloys with compositions as a % by weight within the following ranges: from 3.5 to 5.0 of Cu, from 0.8 to 1.8 of Li, from 0.25 to 1.0 of Mg, from 0.01 to 1.5 of a grain refiner chosen from among Zr, Cr, Mn, Ti, Hf, V, Nb, B, TiB2 and mixtures thereof, the remainder being essentially Al.

U.S. Pat. No. 7,438,772 describes alloys containing the following (percent by weight), Cu=3-5, Mg=0.5-2, Li=0.01-0.9, and discourages the use of higher lithium contents due to a degradation in the balance between toughness and mechanical strength.

Patent application WO2009103899 describes a rolled essentially unrecrystallized product containing the following % by weight: 2.2 to 3.9% by weight of Cu, 0.7 to 2.1% by weight of Li; 0.2 to 0.8% by weight of Mg; 0.2 to 0.5% by weight of Mn; 0.04 to 0.18% by weight of Zr; less than 0.05% by weight of Zn, and optionally 0.1 to 0.5% by weight of Ag, the remainder being aluminum and inevitable impurities, with low propensity to crack bifurcation during a fatigue test in the LS direction.

Patent application WO2010149873 relates to a strain hardened product such as an extruded, rolled and/or forged product made of an aluminum based alloy containing the following % by weight; Cu=3.0-3.9; Li=0.8-1.3; Mg=0.6 to 1.0: Zr=0.05-0.18; Ag=0.0 to 0.5; Mn=0.0 to 0.5: Fe+Si≤ 0.20; Zn≤0.15; at least one element among Ti (from 0.01 to) 0.15: Sc (from 0.05 to 0.3): Cr (from 0.05 to 0,3); Hf (from 0.05-0.5), other elements <0.05 each and <0.15 total, the remainder being aluminum,

Patent application WO2012112942 describes products at least 12.7 mm thick made of aluminum alloy containing (% by weight) from 3.00 to 3.80% of Cu, from 0.05 to 0.35% of Mg, from 0.975 to 1.385% of Li, in which the Li content is between −0.3 Mg−0.15Cu+1.65 and −0.3 Mg−0.15Cu+1.55, from 0.05 to 0.50% of at least one element to control the granular structure chosen from the group composed of Zr, Sc, Cr, V, Hf, other rare earth elements and combinations of them up to 1.0% of Zn, up to 1.0% of

Mn, up to 0.12% of Si, up to 0.15% of Fe, up to 0.15% of Ti, up to 0.10% of other elements, with the total of these other elements not exceeding 0.35%, the remainder being aluminum.

It is observed that products according to prior art made of alloy essentially contain no silver making it impossible to obtain properties as beneficial as those obtained with alloys containing silver such as the AA2050 alloy. In particular, the advantageous balance between the mechanical strength and toughness is not reached for thick products, particularly for thicknesses of at least 12 mm or at least 40 mm, while maintaining satisfactory resistance to corrosion. The addition of silver, that is an element infrequently used in aluminum alloys, could contaminate other alloys during recycling and affect their properties because there is an effect at low contents. Furthermore, the limitation of the quantity of silver is economically very positive. Products with a low sensitivity to quenching would also be particularly advantageous.

There is a need for products made of an aluminum-copper-lithium alloy, particularly thick products, with better properties than known products that contain essentially no silver, particularly in terms of the balance between static mechanical strength properties, damage tolerance properties, thermal stability, resistance to corrosion and machinability, while having a low density.

### SUMMARY

A first purpose of the invention is a rolled and/or forged aluminum-based alloy comprising the following % by weight,
Cu: 3.2-4.0;
Li: 0.80-0.95;
Zn: 0.45-0.70;
Mg: 0.15-0.70;
Zr: 0.07-0.15;
Mn: 0.1-0.6;
Ag %<0.15;
Fe+Si≤0.20;
at least one element from among
Ti: 0.01-0.15;
Sc: 0.02-0.15, preferably 0.02-0.1;
Cr: 0.02-0.3, preferably 0.02-0.1;
Hf: 0.02-0.5;

V: 0.02-0.3, preferably 0.02-0.1;
other elements<0.05 each and <0.15 total, remainder aluminum,

A second purpose of the invention is a method of manufacturing a product according to the invention in which
a) a bath of liquid metal is created based on an aluminum alloy according to the invention;
b) an unwrought product is cast from said liquid metal bath;
c) said unwrought product is homogenized at a temperature of between 450° C. and 550°, and preferably between 480° C. and 530° C. for a duration of between 5 and 60 hours;
d) said unwrought product is hot and optionally cold worked preferably to a thickness of at least 12 mm, preferably at least 15 mm, and even more preferably at least 40 mm into a rolled and/or forged product;
e) said product is solution heat treated at between 490 and 530° C. for 15 minutes to 8 h and is quenched;
f) said product is stress relieved, preferably by stretching, in a controlled manner, with a permanent set of 1 to 7% and preferably at least 4%;
g) said product is aged including heating to a temperature of between 130 and 170° C., preferably between 140 and 160° C., and more preferably between 140 and 150° C., for 5 to 100 hours and preferably 10 to 50 h.

Another purpose of the invention is a structural element of an aircraft comprising a product according to the invention.

### BRIEF DESCRIPTION OF THE DRAWINGS

FIG. 1 represents the balance between the yield stress R_{p0.2} in the LT direction and the toughness K_{1C} in the T-L direction for a thickness of 50 mm.

FIG. 2 represents the balance between the yield stress R_{p0.2} in the ST direction and the toughness K_{1C} in the S-L direction for a thickness of 50 mm.

FIG. 3 represents the balance between the yield stress R_{p0.2} in the LT direction and the toughness K_{1C} in the T-L direction for a thickness of 102 mm.

FIG. 4 represents the balance between the yield stress R_{p0.2} in the ST direction and the toughness K_{1C} in the S-L direction for a thickness of 102 mm.

FIG. 5 represents the balance between the yield stress R_{p0.2} in the ST direction and the toughness K_{1C} in the S-L direction for a thickness of 130 mm.

FIG. 6 represents the difference in toughness for quenching conditions as a function of the difference in yield stress for these two quenching conditions for the tests in example 2.

### DETAILED DESCRIPTION OF A PREFERRED EMBODIMENT

Unless mentioned otherwise, all indications about the chemical composition of alloys are expressed as a percent by weight based on the total weight of the alloy. The expression 1.4 Cu means that the copper content expressed as a % by weight is multiplied by 1.4. Alloys are designated in accordance with the rules of the Aluminum Association, known to an expert in the subject. The definitions of metallurgical tempers are indicated in European standard EN 515 (EN515: 1993).

Unless mentioned otherwise, static mechanical properties, in other words the ultimate strength Rm, the conventional yield stress at 0.2% elongation R_{p0.2}, and elongation at rupture A %, are determined by a tensile test according to standard EN ISO 6892-1:2009 (formerly EN 10002-1:2001), sampling and the direction of the test being defined by standard EN 485-1 (EN 485-1:2008+A1:2009).

The stress intensity factor (K_{Q}) is determined according to standard ASTM E 399 (ASTM E 399-12e3). Standard ASTM E 399 (ASTM E 399-12e3) gives criteria to determine if K_{Q} is a valid value of K_{1C}. For a given test piece geometry, the values of K_{Q} obtained for different materials are comparable with each other provided that the yield stresses of the materials are the same order of magnitude.

A curve giving the effective stress intensity factor as a function of the effective crack extension, known as the R curve, is determined according to ASTM standard E 561 (ASTM E 561-10e2). The critical stress intensity factor K_{c}, in other words the intensity factor that makes the crack unstable, is calculated from the R curve. The stress intensity factor K_{CO} is also calculated by assigning the initial crack length at the beginning of the monotonous load, to the critical load. These two values are calculated for a test piece with the required shape. Kₐₚₚ represents the factor K_{CO} corresponding to the test piece that was used to make the R curve test. K_{eff} represents the factor K_{C} corresponding to the test piece that was used to make the R curve test.

Stress corrosion studies were carried out according to standards ASTM G47 and G49 (ASTM G47-98 (2011) and G49-85 (2011)) along the ST and LT directions for samples taken at mid-thickness.

According to this invention, a selected class of aluminum alloys containing specific and critical quantities of copper, lithium, magnesium, zinc, manganese and zirconium but essentially containing no silver can be used to prepare strain hardened products with an improved balance between toughness and mechanical strength, and good resistance to corrosion.

The inventors have observed that, surprisingly, for thick products it is possible to obtain an at least equivalent balance between static mechanical strength properties and damage tolerance properties as that obtained with an aluminum-copper-lithium allow containing silver, particularly such as the AA2050 alloy, by making a narrow selection of quantities of lithium, copper, magnesium, manganese, zinc and zirconium.

The copper content of products according to the invention is between 3.2 and 4.0% by weight. In one advantageous embodiment of the invention, the copper content is at least 3.3 or preferably at least 3.4% by weight and/or at most 3.8 and preferably at most 3.7% by weight.

The lithium content of products according to the invention is between 0.80 and 0.95% by weight. The lithium content is advantageously between 0.84 and 0.93% by weight. Preferably, the lithium content is at least 0.86% by weight. The silver content is less than 0.15% by weight, preferably less than 0.10% by weight and more preferably less than 0.05% by weight. The inventors have observed that the advantageous balance between the mechanical strength and the damage tolerance known for alloys typically containing 0.3 to 0.4% by weight of silver can be obtained for alloys containing essentially no silver with the selected composition.

The magnesium content of products according to the invention is between 0.15 and 0.7%; and preferably between 0.2 and 0.6% by weight. Advantageously, the magnesium content is at least 0.30% by weight and preferably at least 0.34%, and more preferably at least 0.38% by weight. The inventors have observed that when the magnesium content is less than 0.30% by weight, the advantageous balance between mechanical strength and damage tolerance is not obtained for the highest thicknesses, particularly for thicknesses of more than 76 mm.

The inventors have observed that for the lowest contents of magnesium, typically contents of less than 0.5% by weight, preferably less than 0.45% by weight, the presence of a small quantity of silver can be advantageous, preferably the magnesium content is equal to at least (0.3-1.5*Ag). In one embodiment of the invention, the magnesium content is at most (0.55-1.5*Ag).

In one embodiment of the invention, the magnesium content is at most 0.45% by weight and preferably at most 0.43% by weight. In one advantageous embodiment, the magnesium content is at most 0.45% by weight and preferably at most 0.43% by weight and the Ag content is less than 0.15% by weight, and preferably less than 0.10% by weight.

The zinc content is between 0.45 and 0.70% by weight. Advantageously, the zinc content is between 0.50 and 0.60% by weight that can contribute to achieving the required balance between toughness and mechanical strength. The zirconium content is between 0.07 and 0.15%: and preferably between 0.09 and 0.12% by weight.

The manganese content is between 0.1 and 0.6% by weight. Advantageously, the manganese content is between 0.2 and 0.4% by weight and can improve the toughness without comprising the mechanical strength. If there is no added manganese, the required balance is not achieved.

The sum of the iron content and the silicon content is not more than 0.20% by weight. Preferably, the iron and silicon contents are not more than 0.08% each by weight. In one advantageous embodiment of the invention, the iron and silicon contents are not more than 0.06% and 0.04% by weight respectively.

The alloy also contains at least one element that can contribute to controlling the grain size, chosen from among V, Cr, Sc, Hf and Ti, the quantity of the element, if it is chosen, being from 0.02 to 0.3% by weight, preferably from 0.02 to 0.1 by weight for V, Cr; from 0.02 to 0.15% by weight, preferably from 0.02 to 0.1% by weight for Sc; from 0.02 to 0.5% by weight for Hf and from 0.01 to 0.15% by weight for Ti. Preferably, between 0.02 and 0.10% by weight of titanium will be chosen.

The alloy according to the invention is intended particularly for the manufacture of thick rolled and/or forged products, and more particularly thick rolled products. For the purposes of this invention, thick products means products that are at least 12 mm and preferably at least 40 mm thick. In one advantageous embodiment, the rolled and/or forged products according to the invention are at least 76 mm thick or even at least 121 mm thick.

The thick products according to the invention provide a particularly advantageous balance between mechanical strength and toughness.

When in a rolled and/or forged, solution heat treated, quenched, stretched and aged temper, products according to the invention have at least one of the following pairs of characteristics for thicknesses of between 40 and 75 mm:
(i) at quarter thickness, yield stress R_{p0.2}(LT)≥480 MPa and preferably R_{p0.2}(LT)≥490 MPa and toughness K_{1C} (T-L)≥31 MPa√m and advantageously such that K_{1C} (T-L)≥−0.175 R_{p0.2}(LT)+119.2, preferably K_{1C} (T-L)≥−0.175 R_{p0.2}(LT)+120.5 and preferably K_{1C} (T-L)≥−0.175 R_{p0.2}(LT)+121.5,
(ii) at mid thickness, yield stress R_{p0.2}(ST)≥450 MPa and preferably R_{p0.2}(ST)≥455 MPa and toughness K_{1C} (S-L)≥24 MPa√m and advantageously such that K_{1C} (S-L)≥−0.34 R_{p0.2}(ST)+185.6, preferably K_{1C} (S-L)≥−0.34 R_{p0.2}(ST)+187.2 and preferably K_{1C} (S-L)≥−0.34 R_{p0.2}(ST)+188.7,

Products according to the invention in which the magnesium content is at least 0.34% by weight and preferably at least 0.38% by weight and the silver content is less than 0.10% by weight, and preferably less than 0.05% by weight, are advantageous and when in a rolled and/or forged, solution heat treated, quenched, stress relieved preferably by stretching, and aged temper, have at least one of the following pairs of characteristics for thicknesses of between 76 and 150 mm:
(i) for thicknesses of 76 to 120 mm, at quarter thickness, yield stress R_{p0.2}(LT)≥460 MPa and preferably R_{p0.2}(LT)≥470 MPa and advantageously a toughness K_{1C} (T-L)≥27 MPa√m and such that K_{1C} (T-L)≥−0.1 R_{p0.2}(LT)+77, preferably K_{1C} (T-L)≥−0.1 R_{p0.2}(LT)+78 and preferably K_{1C} (T-L)≥−0.1 R_{p0.2}(LT)+79,
(ii) for thicknesses of 76 to 120 mm, at mid thickness, yield stress R_{p0.2}(ST)≥435 MPa and preferably R_{p0.2}(ST)≥445 MPa and toughness K_{1C} (S-L)≥23 MPa√m and advantageously such that K_{1C} (S-L)≥−0.25 R_{p0.2}(ST)+139.25, preferably K_{1C} (S-L)≥−0.25 R_{p0.2}(ST)+140.85 and preferably K_{1C} (S-L)≥−0.25 R_{p0.2}(ST)+142.45,
(iii) for thicknesses of 121 to 150 mm, at mid thickness, yield stress R_{p0.2}(ST)≥420 MPa and preferably R_{p0.2}(ST)≥425 MPa and toughness K_{1C} (S-L)≥20 MPa√m and advantageously such that K_{1C} (S-L)≥−0.25 R_{p0.2}(ST)+133, preferably K_{1C} (S-L)≥−0.25 R_{p0.2}(ST)+133.5 and preferably K_{1C} (S-L)≥−0.25 R_{p0.2}(ST)+134,

Products according to the invention also have advantageous properties in terms of toughness as measured according to standard ASTM E561 (ASTM E 561-10e2). Thus, when in a rolled and/or forged, solution heat treated, quenched, stress relieved preferably by stretching, and aged temper, products according to the invention have at least one of the following pairs of characteristics for thicknesses of between 40 and 150 mm, the toughness in plane stress Kₐₚₚ being measured on test pieces type CCT406 (2ao=101.6 mm)
(i) for thicknesses of between 40 and 75 mm Kₐₚₚ, in the L-T direction of at least 105 MPa √m and preferably at least 110 MPa √m and a yield stress R_{p0.2}(L) equal to at least 500 MPa and preferably at least 510 MPa,
(ii) for thicknesses of between 40 and 75 mm Kₐₚₚ, in the T-L direction of at least 60 MPa √m and preferably at least 70 MPa √m and a yield stress R_{p0.2}(LT) equal to at least 480 MPa and preferably at least 490 MPa,
(iii) for thicknesses of between 76 and 120 mm Kₐₚₚ, in the L-T direction at least 80 MPa √m and preferably at least 90 MPa √m and a yield stress R_{p0.2}(L) equal to at least 475 MPa and preferably at least 485 MPa,
(iv) for thicknesses of between 76 and 120 mm Kₐₚₚ, in the T-L direction of at least 40 MPa √m and preferably at least 50 MPa √m and a yield stress R_{p0.2}(LT) equal to at least 455 MPa and preferably at least 465 MPa,
(v) for thicknesses of between 121 and 150 mm Kₐₚₚ, in the L-T direction of at least 75 MPa √m and preferably at least 80 MPa √m and a yield stress R_{p0.2}(L) equal to at least 470 MPa and preferably at least 480 MPa,
(vi) for thicknesses of between 121 and 150 mm Kₐₚₚ, in the T-L direction of at least 40 MPa √m and preferably at least 45 MPa √m and a yield stress R_{p0.2}(LT) equal to at least 445 MPa and preferably at least 455 MPa.

The resistance of products according to the invention to stress corrosion is generally high; advantageously, the number of days before failure tested according to ASTM standards G47 and G49 (ASTM G47-98 (2011) and G49-85 (2011)) at mid-thickness for a stress in the ST direction equal to 350 MPa is at least 30 days and preferably, particularly for plates between 40 and 75 mm thick, the number of days before failure for a stress of 450 MPa in the ST direction is at least 30 days.

The method of manufacturing products according to the invention includes steps for production, casting, rolling and/or forging, solution heat treatment, quenching, stress relieving and ageing.

In a first step, a liquid metal bath is produced so as to obtain an aluminum alloy with a composition according to the invention.

The liquid metal bath is then poured as an unwrought product, typically a rolling slab or as forging stock.

The unwrought product is then homogenized at a temperature of between about 450° C. and 550°, and preferably between about 480° C. and 530° C. for a duration of between 5and 60 hours;

After homogenization, the unwrought product is generally cooled to ambient temperature before being preheated to be hot worked. The purpose of preheating is to reach a temperature preferably between 400 and 550° C. and preferably of the order of 500° C. so that the unwrought product can be worked.

Hot working is achieved by rolling and/or forging so as to obtain a rolled and/or forged product preferably with a thickness of at least 12 mm and preferably at least 40 mm. The product is then solution heat treated at between 490 and 550° C. for 15 minutes to 8 hours, then quenched typically in water at ambient temperature. The product is then subjected to controlled stress relieving, preferably by tension and/or by compression, with a permanent set of 1 to 7% and preferably at least 2%. The rolled products are preferably subjected to controlled stretching with a permanent set equal to at least 4%. In one advantageous embodiment of the invention that in particular can improve the balance between static mechanical strength and toughness, the controlled stretching is done with a permanent set of between 5 and 7%. The preferred metallurgical tempers are the T84 and T86 tempers, and preferably T86. Steps such as rolling, planing, straightening, shaping can be done optionally after solution heat treatment and before or after controlled stretching. In one embodiment of the invention, a cold rolling step is done to at least 7% and preferably at least 9% before applying controlled stretching with a permanent set of from 1 to 3%.

Said product is aged including heating to a temperature of between 130 and 170° C., preferably between 140 and 160° C., and more preferably between 140 and 150° C., for 5 to 100 hours and preferably 10 to 50 h. The inventors have observed that the balance between mechanical strength and toughness can be improved by ageing within the preferred range. In one advantageous embodiment, controlled stretching is applied with a permanent set of between 5 and 7% and ageing is done at a temperature of between 140 and 160° C., preferably between 140 and 150° C., for a duration of 10 to 30 h.

Products according to the invention can advantageously be used in structural elements, and particularly in aircraft. For the purposes of this description, a “structure element” or “structural element” in mechanical construction means a mechanical part for which the static and/or dynamic properties are particularly important for performance of the structure, and for which a structural calculation is normally specified or is performed. These are typically elements that, if they fail, could jeopardize the safety of said construction, its users or others. For the purposes of this invention, these aircraft structural elements include particularly bulkheads, wings (such as the wing skin), ribs and spars and the tail plane composed particularly of horizontal or vertical stabilizer, and doors.

The use of a structure element incorporating at least one product according to the invention or fabricated from such a product is advantageous, particularly for aeronautical construction. Products according to the invention are particularly advantageous for manufacturing products machined from one block, particularly for lower wing skin or upper wing skin elements for which the skin and stiffeners originate from the same initial product, spars and ribs, and also for any other use for which these properties could be advantageous.

These and other aspects of the invention are explained in more detail by means of the following illustrative and non-limitative examples.

### EXAMPLES

### Example 1

In this example, several 400 mm thick slabs with the composition given in table 1 were cast.

TABLE 1
Composition as a % by weight of Al—Cu—Li alloys cast in the form of a slab.

| | Cu | Mn | Mg | Zn | Li | Ag | Zr | Fe | Si | Ti |
|---|---|---|---|---|---|---|---|---|---|---|
| 54 | 3.61 | 0.34 | 0.17 | 0.56 | 0.93 | 0.13 | 0.10 | 0.023 | 0.015 | 0.022 |
| 55 | 3.60 | 0.52 | 0.17 | 0.54 | 0.94 | 0.13 | 0.10 | 0.023 | 0.015 | 0.021 |
| 56 | 3.60 | 0.34 | 0.43 | 0.57 | 0.93 | 0.00 | 0.10 | 0.021 | 0.015 | 0.022 |
| 57 | 3.62 | 0.55 | 0.34 | 0.56 | 0.95 | 0.00 | 0.10 | 0.017 | 0.015 | 0.023 |
| 71 | 3.62 | 0.36 | 0.43 | 0.56 | 0.90 | 0.01 | 0.10 | 0.040 | 0.024 | 0.031 |
| 72 | 3.55 | 0.00 | 0.51 | 0.56 | 0.90 | 0.00 | 0.10 | 0.035 | 0.023 | 0.029 |

The slabs were homogenized at about 500° C. for about 12 hours and then scalped. The 30 slabs were then hot rolled to obtain 50 mm, 102 mm or 130 mm thick slabs. The plates were solution heat treated at 527° C. and quenched with cold water. The plates were then stretched to give a permanent elongation of 4% or 6%.

The plates were aged at 145° C. or at 150° C. Samples were taken at ¼-thickness to measure the static mechanical properties in tension and in toughness in the L, LT, L-T and T-L directions at ½-thickness to measure the static mechanical properties in tension and in toughness in the ST and S-L directions. The test pieces used for measuring the toughness were test pieces with CT geometry and their dimensions were as defined below:

| Thick- | | | |
|---|---|---|---|
| ness | L-T | T-L | S-L |
| 50 mm | Thickness B = | Thickness B = | Thickness B = |
| | 20 mm | 20 mm | 15 mm |
| | Width W = 40 mm | Width W = 40 mm | Width W = 30 mm |
| 102 mm | Thickness B = | Thickness B = | Thickness B = |
| | 40 mm | 40 mm | 30 mm |
| | Width W = 80 mm | Width W = 80 mm | Width W = 60 mm |
| 130 mm | Thickness B = | Thickness B = | Thickness B = |
| | 40 mm | 40 mm | 30 mm |
| | Width W = 80 mm | Width W = 80 mm | Width W = 60 mm |

The results are given in table 2 and table 3.

TABLE 2
Static mechanical properties obtained for different plates.

| | | Permanent | | | | | | | | | | |
|---|---|---|---|---|---|---|---|---|---|---|---|---|
| | | set | | | | | | | | | | |
| | Final | (controlled | | RmL | Rp02L | | RmLT | Rp02LT | a | RmST | Rp02ST | |
| Alloy | thickness | stretching) | Aged | (MPa) | (MPa) | A % L | (MPa) | (MPa) | % LT | (MPa) | (MPa) | A % L |
| 54 | 50 mm | 4% | 145° C. 53 h | | | | 542 | 495 | 9.3 | 540 | 464 | 6.7 |
| 54 | 50 mm | 4% | 150° C. 40 h | 548 | 516 | 11.1 | 545 | 499 | 9.6 | 543 | 473 | 5.8 |
| 54 | 102 mm | 4% | 150° C. 40 h | 535 | 500 | 9.5 | 541 | 489 | 4.9 | 510 | 460 | 1.2 |
| 55 | 50 mm | 4% | 150° C. 40 h | 546 | 512 | 10.2 | 536 | 490 | 9.0 | 528 | 464 | 5.5 |
| 55 | 102 mm | 4% | 145° C. 53 h | | | | 517 | 467 | 7.3 | 503 | 439 | 4.2 |
| 56 | 50 mm | 4% | 145° C. 53 h | | | | 540 | 491 | 10.0 | 540 | 463 | 5.3 |
| 56 | 50 mm | 6% | 150° C. 22 h | | | | 527 | 481 | 11.6 | 533 | 453 | 7.0 |
| 56 | 50 mm | 6% | 150° C. 30 h | | | | 538 | 493 | 10.2 | 536 | 461 | 5.2 |
| 56 | 50 mm | 6% | 150° C. 40 h | | | | 542 | 499 | 9.6 | 544 | 467 | 6.2 |
| 56 | 50 mm | 4% | 150° C. 40 h | 551 | 522 | 10.3 | 543 | 494 | 9.1 | 549 | 468 | 6.2 |
| 56 | 102 mm | 4% | 145° C. 53 h | | | | 523 | 469 | 7.4 | 520 | 442 | 4.8 |
| 56 | 102 mm | 4% | 150° C. 40 h | 532 | 500 | 9.7 | 534 | 477 | 5.9 | 524 | 452 | 3.6 |
| 57 | 102 mm | 4% | 145° C. 53 h | | | | 518 | 466 | 7.7 | 509 | 440 | 4.2 |
| 57 | 102 mm | 6% | 150° C. 30 h | | | | 521 | 473 | 8.1 | 509 | 449 | 3.8 |
| 57 | 102 mm | 6% | 150° C. 40 h | | | | 527 | 479 | 6.7 | 516 | 453 | 3.8 |
| 71 | 130 mm | 6% | 150° C. 20 h | | | | 509 | 454 | 7.7 | 495 | 427 | 4.3 |
| 71 | 130 mm | 6% | 150° C. 30 h | | | | 519 | 465 | 6.4 | 506 | 437 | 3.9 |
| 71 | 130 mm | 6% | 150° C. 40 h | | | | 527 | 476 | 5.4 | 515 | 447 | 3.6 |
| 71 | 130 mm | 6% | 150° C. 50 h | | | | 527 | 478 | 5.5 | 516 | 451 | 3.1 |
| 72 | 102 mm | 6% | 150° C. 30 h | | | | 526 | 475 | 3.7 | 501 | 449 | 1.7 |

TABLE 3
Toughness properties K1C obtained for the different plates.

| | | Permanent | | K1C (*:Kq) | | |
|---|---|---|---|---|---|---|
| | | set | | L-T | | K1C (*:Kq) |
| | Final | (controlled | | (MPa | K1C T-L | S-L |
| Alloy | thickness | stretching) | Aged | √m) | (MPa √m) | (MPa √m) |
| 54 | 50 mm | 4% | 145° C. 53 h | | 33.0 | 31.1 |
| 54 | 50 mm | 4% | 150° C. 40 h | 36.2* | 32.8 | 31.0 |
| 54 | 102 mm | 4% | 150° C. 40 h | 30.3* | 25.9 | 24.9* |
| 55 | 50 mm | 4% | 150° C. 40 h | 39.9 | 33.6 | 28.8 |
| 55 | 102 mm | 4% | 145° C. 53 h | | 30.7 | 30.3 |
| 56 | 50 mm | 4% | 145° C. 53 h | | 34.6 | 29.6* |
| 56 | 50 mm | 6% | 150° C. 22 h | | 38.0 | 33.2* |
| 56 | 50 mm | 6% | 150° C. 30 h | | 35.7 | 32.6* |
| 56 | 50 mm | 6% | 150° C. 40 h | | 33.8 | 30.6 |
| 56 | 50 mm | 4% | 150° C. 40 h | 39.6 | 34.4 | 29.0 |
| 56 | 102 mm | 4% | 145° C. 53 h | | 31.6 | 30.2 |
| 56 | 102 mm | 4% | 150° C. 40 h | 34.0* | 29.8 | 27.3 |
| 57 | 102 mm | 4% | 145° C. 53 h | | 31.5 | 30.3 |
| 57 | 102 mm | 6% | 150° C. 30 h | | 31.8 | 31.7 |
| 57 | 102 mm | 6% | 150° C. 40 h | | 30.7 | 29.5 |
| 71 | 130 mm | 6% | 150° C. 20 h | | 29.4 | 27.7 |
| 71 | 130 mm | 6% | 150° C. 30 h | | 26.3 | 25.1 |
| 71 | 130 mm | 6% | 150° C. 40 h | | 24.5 | 21.4* |
| 71 | 130 mm | 6% | 150° C. 50 h | | 23.9 | 22.1 |
| 72 | 102 mm | 6% | 150° C. 30 h | | 24.2 | 21.7 |

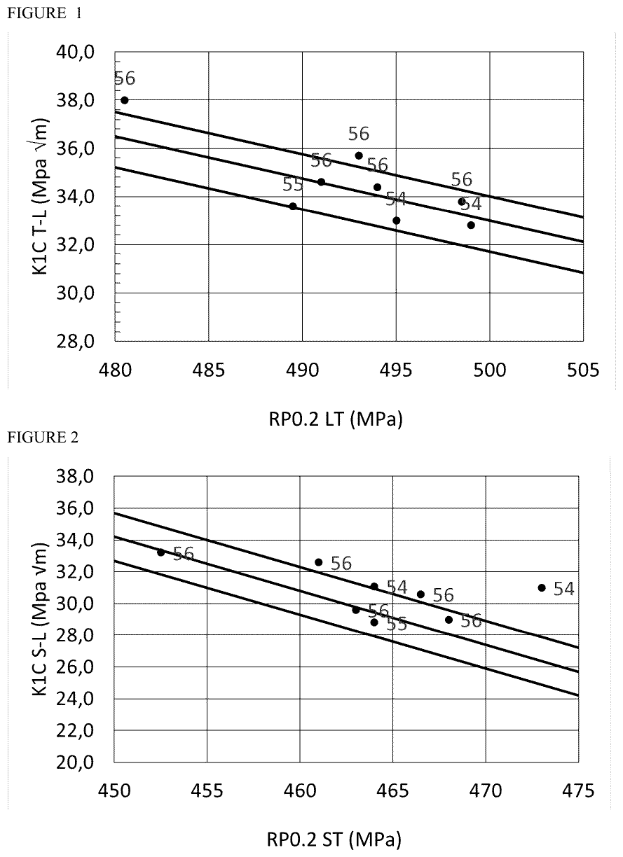

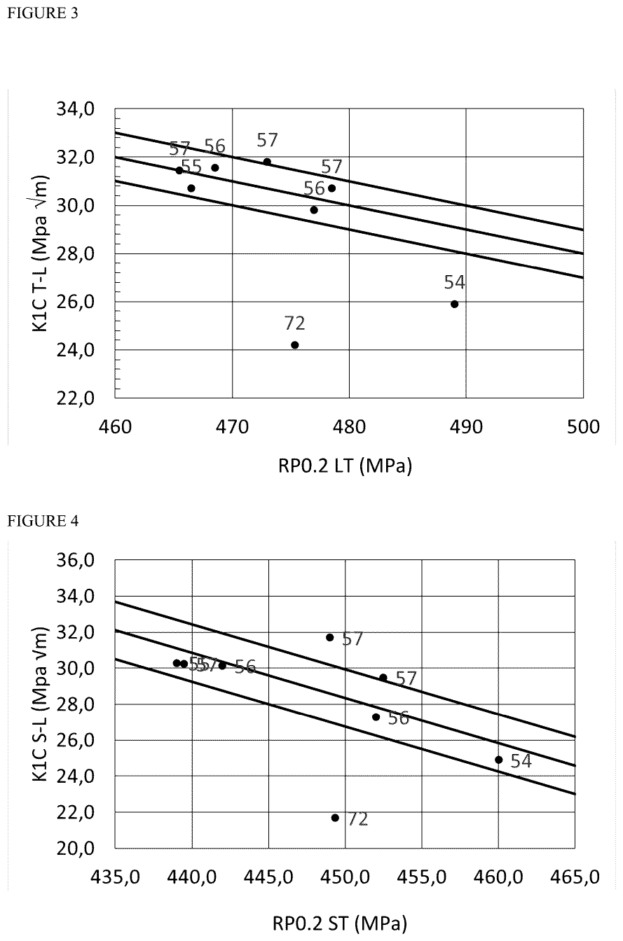

The results are illustrated in FIGS. 1 to 2 (thickness 50 mm) and 3 and 4 (thickness 102 mm) and 5 (thickness 130) mm).

The stress corrosion results obtained are presented in Table 4 below.

TABLE 4
Results of stress corrosion tests

| | | | | | | | Number of |
|---|---|---|---|---|---|---|---|
| | | Permanent set | | | | | days |
| | | (controlled | Ageing | Ageing | Stress level | | without |
| | Thickness | stretching) | temperature | duration | (MPa) | Direction | failure |
| 54 | 50 mm | 4% | 150° C. | 40 | 450 | ST and LT | 30 |
| 54 | 102 mm | 4% | 150° C. | 40 | 350 | ST | 30 |
| 55 | 50 mm | 4% | 150° C. | 40 | 450 | ST and LT | 30 |
| 55 | 102 mm | 4% | 150° C. | 40 | 350 | ST | 30 |
| 56 | 50 mm | 4% | 150° C. | 40 | 450 | ST and LT | 30 |
| 56 | 102 mm | 4% | 150° C. | 40 | 350 | ST | 30 |
| 57 | 102 mm | 4% | 150° C. | 40 | 350 | ST | 30 |

### Example 2

In this example, several 120 mm thick slabs with the composition given in table 5 were cast.

TABLE 5
Composition as a % by weight of Al—Cu—Li cast in the form of a slab.

| Alloy | Cu | Mn | Mg | Zn | Li | Ag | Zr | Fe | Si | Ti |
|---|---|---|---|---|---|---|---|---|---|---|
| 58 | 3.68 | 0.33 | 0.30 | 0.68 | 0.81 | 0.00 | 0.10 | 0.021 | 0.015 | 0.025 |
| 59 | 3.64 | 0.35 | 0.32 | 0.00 | 0.85 | 0.12 | 0.10 | 0.023 | 0.015 | 0.025 |
| 61 | 3.64 | 0.34 | 0.51 | 0.66 | 0.84 | 0.00 | 0.10 | 0.020 | 0.015 | 0.025 |
| 62 | 3.67 | 0.35 | 0.33 | 0.70 | 0.86 | 0.14 | 0.10 | 0.020 | 0.015 | 0.025 |

The slabs were machined to a thickness of 100 mm. The slabs were homogenized at about 500° C. for about 12 hours and then scalped. After homogenization, the slabs were hot rolled to obtain 27 mm thick slabs. The plates were solution heat treated and quenched in cold water or in hot water at 90° C. so as to vary the quenching rate and stretched with a permanent set of 3.5%.

The plates were aged at between 15 h and 50 h at 155° C. Samples were taken at mid-thickness to measure static mechanical properties in tension and the toughness K_{Q}. The width W of the test pieces used to measure the toughness in the T-L direction was 50 mm and their width B was 25 mm. The validity criteria of K_{1C} were satisfied for all samples. For the S-L direction, the measurements were made on test pieces with width W=36 mm and thickness B=25.4 mm. The results obtained are given in tables 6 and 7.

TABLE 6
Mechanical properties obtained for the different plates
after quenching in water at 90° C.

| | Ageing | RmLT | Rp02LT | | K1C T-L | Kq S-L |
|---|---|---|---|---|---|---|
| | duration | (MPa) | (MPa) | A % L | (MPa √m) | (MPa √m) |
| 58 | 15 | 495 | 441 | 10.3 | 28.4 | 30.3 |
| | 18 | 506 | 455 | 9.6 | 26.3 | 26.2 |
| | 24 | 514 | 466 | 8.8 | 24.7 | 26.6 |
| | 50 | 521 | 476 | 8.5 | 23.5 | 23.7 |
| 59 | 15 | 485 | 427 | 11.1 | 28.5 | 28.5 |
| | 18 | 496 | 443 | 7.6 | 26.2 | 26.0 |
| | 24 | 505 | 453 | 10.3 | 25.2 | 25.3 |
| | 50 | 510 | 463 | 9.2 | 23.6 | 24.1 |
| 61 | 15 | 496 | 435 | 8.5 | 30.9 | 37.0 |
| | 18 | 512 | 453 | 7.1 | 29.8 | 27.5 |
| | 24 | 521 | 466 | 7.6 | 27.7 | 25.6 |
| | 50 | 530 | 480 | 5.9 | 23.4 | 24.7 |
| 62 | 15 | 517 | 462 | 10.1 | 25.4 | 26.3 |
| | 18 | 524 | 470 | 9.1 | 24.3 | 23.6 |
| | 24 | 528 | 475 | 8.4 | 23.6 | 23.7 |
| | 50 | 532 | 483 | 6.4 | 21.4 | 23.0 |

TABLE 7
Mechanical properties obtained for the different plates
after quenching in water at 25° C.

| | Ageing | RmLT | Rp02LT | | K1C T-L | Kq S-L |
|---|---|---|---|---|---|---|
| | duration | (MPa) | (MPa) | A % L | (MPa √m) | (MPa √m) |
| 58 | 15 | 503 | 455 | 10.7 | 48.0 | 60.9 |
| | 18 | 512 | 465 | 10.7 | 46.9 | 62.1 |
| | 24 | 520 | 474 | 10.7 | 43.8 | 55.2 |
| | 50 | 530 | 488 | 8.9 | 38.9 | 51.1 |
| 59 | 15 | 507 | 458 | 11.7 | 45.4 | 53.1 |
| | 18 | 516 | 471 | 11.5 | 42.1 | 52.0 |
| | 24 | 522 | 478 | 11.4 | 41.4 | 49.1 |
| | 50 | 531 | 491 | 10.0 | 38.1 | 44.9 |
| 61 | 15 | 505 | 450 | 10.2 | 46.1 | 59.2 |
| | 18 | 522 | 474 | 7.3 | 40.9 | 54.2 |
| | 24 | 535 | 487 | 8.0 | 40.6 | 52.2 |
| | 50 | 546 | 501 | 7.1 | 34.7 | 44.5 |
| 62 | 15 | 530 | 481 | 12.4 | 45.7 | 53.4 |
| | 18 | 539 | 493 | 11.0 | 41.3 | 51.9 |
| | 24 | 545 | 499 | 10.0 | 39.6 | 50.4 |
| | 50 | 551 | 508 | 9.9 | 35.7 | 47.5 |

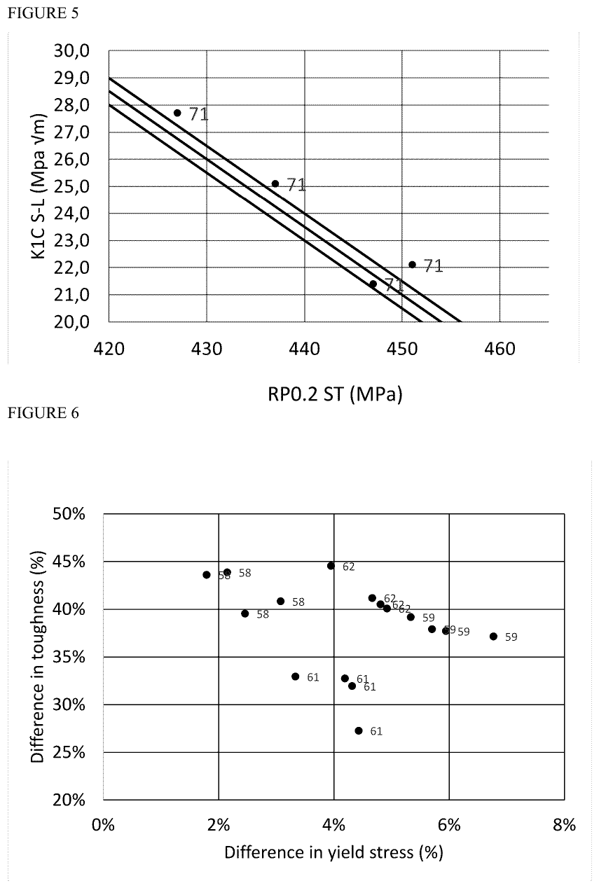

FIG. 6 shows the reduction in properties (mechanical strength, toughness) for quenching in water at 90° C. as a percentage relative to the value with quenching in water at 25° C. Composition 61 is the least sensitive to quenching for toughness, and composition 58 is the least sensitive to quenching for the yield stress.

### Example 3

In this example, we studied the effect of controlled stretching and ageing on toughness results Kₐₚₚ and K_{eff} measured by an R curve.

50 mm and 102 mm thick plates were obtained with alloys 56 and 71 in table 1. The plates were solution heat treated at 527° C. and were quenched in cold water. Plates made of alloy 56 were then stretched to a permanent elongation of 4% and plates made of alloy 71 were stretched to a permanent elongation of 6%.

Plates made of alloy 56 were then aged for 40 hours at 150° C. and plates made of alloy 71 were aged for 20 hours at 150° C.

Samples were taken at ½ thickness for 50 mm thick plates and at ¼-thickness for 102 mm and 130 mm thick plates, to measure mechanical static tension and toughness characteristics in plain stress Kₐₚₚ and K_{eff} in the L, LT, L-T and T-L directions. For toughness, the R curve was measured on CCT test pieces with width W=406 mm and thickness B=6.35 mm. The results are summarized in Table 8 below:

TABLE 8
measured mechanical properties

| | | | | Rp0.2 | | | | |
|---|---|---|---|---|---|---|---|---|
| Thickness | Aged | | Rp0.2 | LT | Kapp L-T | Keff L-T | Kapp T-L | Keff T-L |
| (mm) | tension | Alloy | L MPa | MPa | [MPa√m] | [MPa√m] | [MPa√m] | [MPa√m] |
| 50 | 4% 40 h | 56 | 522 | 494 | 110 | 138 | 61 | 69 |
| 50 | 6% 20 h | 71 | 510 | 487 | 114 | 146 | 74 | 81 |
| 102 | 4% 40 h | 56 | 500 | 477 | 83 | 95 | 46 | 52 |
| 102 | 6% 20 h | 71 | 490 | 467 | 99 | 121 | 51 | 61 |
| 130 | 6% 20 h | 71 | 483 | 460 | 86 | 100 | 47 | 53 |

The combination of controlled stretching with a permanent set of 6% and 20 hours at 150° C. is particularly advantageous.

1. A rolled and/or forged aluminum-based alloy product comprising the following % by weight,
Cu: 3.2-4.0;
Li: 0.80-0.95;
Zn: 0.45-0.70;
Mg: 0.15-0.7;
Zr: 0.07-0.15;
Mn: 0.1-0.6;
Ag: <0.15;
Fe +Si≤0.20;
at least one element from among
Ti: 0.01-0.15;
Sc: 0.02-0.15;
Cr: 0.02-0.3;
Hf: 0.02-0.5;
V: 0.02-0.3;
other elements ≤0.05 each and ≤0.15 total, remainder aluminum.

2. The product according to claim 1, wherein the magnesium content is at most (0.55-1.5*Ag).

3. The product according to claim 1, wherein the copper content is between 3.3 and 3.8% by weight.

4. The product according to claim 1, wherein the zinc content is between 0.50 and 0.60% by weight.

5. The product according to claim 1, wherein the manganese content is between 0.2 and 0.4% by weight.

6. The product according to claim 1, wherein the lithium content is between 0.84% and 0.93% by weight.

7. The product according to claim 1, wherein a thickness of the product is at least 12 mm.

8. The product according to claim 1, in a rolled and/or forged state, with solution heat treatment, quenched, stress relieved, and aged temper, having at least one of the following pairs of characteristics for thicknesses between 40 and 75 mm:
(i) at quarter thickness, yield stress R_{p0.2}(LT)≥480 MPa and toughness K_{1C} (T-L)≥31 MPa√m and advantageously such that K_{1C} (T-L)≥−0.175 R_{p0.2}(LT)+119.2,
(ii) at mid thickness, yield stress R_{p0.2}(ST)≥450 MPa and toughness K_{1C} (S-L)≥24 MPa√m and advantageously such that K_{1C} (S-L)≥−0.34 R_{p0.2}(ST)+185.6.

9. The product according to claim 1, in a rolled and/or forged state, solution heat treatment, quenched, stress relieved, and aged temper, having at least one of the following pairs of characteristics for thicknesses of between 40 and 150 mm, the toughness in plane stress Kₐₚₚ being measured on test pieces type CCT406 (2ao=101.6 mm)
(i) for thicknesses of between 40 and 75 mm Kₐₚₚ, in the L-T direction of at least 105 MPa √m and a yield stress R_{p0.2}(L) equal to at least 500 MPa,
(ii) for thicknesses of between 40 and 75 mm Kₐₚₚ, in the T-L direction of at least 60 MPa √m and a yield stress R_{p0.2}(LT) equal to at least 480 MPa.
(iii) for thicknesses of between 76 and 120 mm Kₐₚₚ, in the L-T direction of at least 80 MPa √m and a yield stress R_{p0.2}(L) equal to at least 475 MPa.
(iv) for thicknesses of between 76 and 120 mm Kₐₚₚ, in the T-L direction of at least 40 MPa √m and a yield stress R_{p0.2}(LT) equal to at least 455 MPa.
(v) for thicknesses of between 121 and 150 mm Kₐₚₚ, in the L-T direction of at least 75 MPa √m and a yield stress R_{p0.2}(L) equal to at least 470 MPa,
(vi) for thicknesses of between 121 and 150 mm Kₐₚₚ, in the T-L direction of at least 40 MPa √m and a yield stress R_{p0.2}(LT) equal to at least 445 MPa.

10. The product according to claim 1, wherein the magnesium content is at least 0.34% by weight, and the silver content is less than 0.05% by weight.

11. The product according to claim 10, in a rolled and/or forged state, with solution heat treatment, quenched, stress relieved, and aged temper, having at least one of the following pairs of characteristics for thicknesses of between 76 and 150 mm:
(i) for thicknesses of 76 to 120 mm, at quarter thickness, yield stress R_{p0.2}(LT)>460 MPa and a toughness K_{1C} (T-L)≥27 MPa√m and advantageously such that K_{1C} (T-L)≥−0.1 R_{p0.2}(LT)+77,
(ii) for thicknesses of 76 to 120 mm, at mid thickness, yield stress R_{p0.2}(ST)≥435 MPa and toughness K_{1C} (S-L)≥23 MPa√m and advantageously such that K_{1C} (S-L)≥−0.25 R_{p0.2}(ST)+139.25,
(iii) for thicknesses of 121 to 150 mm, at mid thickness, yield stress R_{p0.2}(ST)≥420 MPa and toughness K_{1C} (S-L)≥20 MPa√m and advantageously such that K_{1C} (S-L)≥−0.25 R_{p0.2}(ST)+133.

12. The product according to claim 1, in a rolled and/or forged state, with solution heat treatment, quenched, stress relieved, and aged temper, for which the number of days before failure tested according to ASTM standards G47 and G49 at mid-thickness for a stress in the ST direction equal to 350 MPa is at least 30 days and, for plates between 40 and 75 mm thick, the number of days before failure for a stress of 450 MPa in the ST direction is at least 30 days.

13. A method of manufacturing a rolled and/or forged product based on an aluminum alloy, comprising
a) a bath of liquid metal is created, comprising:
Cu: 3.2-4.0;
Li: 0.80-0.95;
Zn: 0.45-0.70;
Mg: 0.15-0.7;
Zr: 0.07-0.15;
Mn: 0.1-0.6;
Ag: <0.15;
Fe+Si≤0.20;
at least one element from among
Ti: 0.01-0.15;
Sc: 0.02-0.15;
Cr: 0.02-0.3;
Hf: 0.02-0.5;
V: 0.02-0.3;
other elements ≤0.05 each and ≤0.15 total, remainder aluminum;
b) an unwrought product is cast from said liquid metal bath;
c) said unwrought product is homogenized at a temperature of between 450° C. and 550° C. for a duration of between 5 and 60 hours;
d) said unwrought product is hot and optionally cold worked to a thickness of at least 12 mm into a rolled and/or forged product;
e) said product is solution heat treated at between 490 and 530° C. for 15 minutes to 8 h and is quenched;
f) said product is stress relieved in a controlled manner, with a permanent set of 1 to 7%;
g) said product is aged including heating to a temperature of between 130 and 170° C., for 5 to 100 hours.

14. The method according to claim 13, wherein the controlled stretching is applied with a permanent set of between 5 and 7% and the ageing time is between 10 and 30 hours.

15. Structural element of an aircraft, preferably the lower wing skin or upper wing skin element in which the skin and the stiffeners are made from the same initial product, a spar or a rib, comprising the product according to claim 1.

16. The product according to claim 1, wherein the copper content is between 3.4 and 3.7% by weight.

17. The product according to claim 1, wherein the lithium content is at least 0.86% by weight.

18. The product according to claim 1, wherein the thickness of the product is at least 40 mm.

19. The method according to claim 13, wherein said unwrought product is homogenized at a temperature of between 480° C. and 530° C.

20. The method according to claim 13, wherein said unwrought product is hot and optionally cold worked to a thickness of at least 40 mm into a rolled and/or forged product.
